(19) United States
(12) Patent Application Publication
(10) Pub. No.: US 2021/0043922 A1
(43) Pub. Date: Feb. 11, 2021

(54) LAYERED OXIDE COMPOSITE CATHODES FOR LITHIUM-ION BATTERIES

(71) Applicant: SF Motors, Inc., Santa Clara, CA (US)

(72) Inventors: Chien-Po Huang, Santa Clara, CA (US); Chengyu Mao, Santa Clara, CA (US); Yu-Hsin Huang, Santa Clara, CA (US); Ying Liu, Santa Clara, CA (US); Yifan Tang, Santa Clara, CA (US)

(21) Appl. No.: 16/533,322

(22) Filed: Aug. 6, 2019

(51) Int. Cl. H01M 4/36; H01M 10/0525; H01M 4/525; H01M 4/505; B60L 50/64

(52) U.S. Cl. CPC H01M 4/364; H01M 10/0525; H01M 4/525; H01M 2004/028; B60L 50/64; H01M 2220/20; H01M 4/505

(57) ABSTRACT

Provided herein are apparatus, systems, and methods of powering electrical vehicles. The apparatus can include a battery pack disposed in an electric vehicle to power the electric vehicle. The apparatus can include a battery cell arranged in the battery pack. The battery cell can have a housing that defines a cavity within the housing of the battery cell. The battery cell can have an electrolyte having a first side and a second side to transfer lithium ions between the first side and the second side. The electrolyte can be arranged within the cavity. The battery cell can have an anode disposed within the cavity along the first side of the electrolyte. The battery cell can have a composite cathode disposed within the cavity along the second side of the electrolyte. The composite cathode can include a mixture of a NCA material and a NCM material.

### BACKGROUND

Batteries can include electrochemical cells to supply electrical power to various electrical components connected thereto.

### SUMMARY

The present disclosure is directed to batteries cells for battery packs. The battery cell can be a lithium-ion battery cell with a composite cathode. The composite cathode can be comprised of a blended mixture of two nickel-based layered oxides, such as lithium nickel cobalt aluminum oxide (NCA) and lithium nickel manganese cobalt oxide (NCM), at an optimal, predetermined ratio. Individually, NCA can have a higher specific capacity but lower thermal stability. NCM, conversely, can have lower specific capacity but higher thermal stability. By mixing these materials at the predetermined ratio, the lithium-ion battery cell can achieve both higher specific capacity and thermal stability.

At least one aspect is directed to an apparatus to power electrical vehicles. The apparatus can include a battery pack disposed in an electric vehicle to power the electric vehicle. The apparatus can include a battery cell arranged in the battery pack. The battery cell can have a housing that defines a cavity within the housing of the battery cell. The battery cell can have an electrolyte having a first side and a second side to transfer lithium ions between the first side and the second side. The electrolyte can be arranged within the cavity. The battery cell can have an anode disposed within the cavity along the first side of the electrolyte. The anode can be electrically coupled with a negative terminal. The battery cell can have a composite cathode disposed within the cavity along the second side of the electrolyte. The composite cathode can be electrically coupled with a positive terminal. The composite cathode can include a lithium nickel cobalt aluminum oxide (NCA) material and a lithium nickel manganese cobalt oxide (NCM) material.

At least one aspect is directed to a method of providing battery cells to power electric vehicles. The method can include disposing a battery pack in an electric vehicle to power the electric vehicle. The method can include arranging a battery cell in the battery pack. The battery cell can have a housing that defines a cavity within the housing of the battery cell. The method can include arranging, within the cavity, an electrolyte having a first side and a second side to transfer lithium ions between the first side and the second side. The method can include disposing, within the cavity, an anode disposed along the first side of the electrolyte, the anode electrically coupled with a negative terminal. The method can include disposing, within the cavity, a composite cathode along the second side of the electrolyte. The composite cathode can be electrically coupled with a positive terminal. The composite cathode can include a lithium nickel cobalt aluminum oxide (NCA) material and a lithium nickel manganese cobalt oxide (NCM) material.

At least one aspect is directed to an electric vehicle. The electric vehicle can include one or more components. The electric vehicle can include a battery pack to power the one or more components. The electric vehicle can include a battery cell arranged in the battery pack. The battery cell can have a housing that defines a cavity within the housing of the battery cell. The battery cell can have an electrolyte having a first side and a second side to transfer lithium ions between the first side and the second side. The electrolyte can be arranged within the cavity. The battery cell can have an anode disposed within the cavity along the first side of the electrolyte. The anode can be electrically coupled with a negative terminal. The battery cell can have a composite cathode disposed within the cavity along the second side of the electrolyte. The composite cathode can be electrically coupled with a positive terminal. The composite cathode can include a lithium nickel cobalt aluminum oxide (NCA) material and a lithium nickel manganese cobalt oxide (NCM) material.

At least one aspect is directed to a method. The method can include providing an apparatus. The apparatus can include a battery pack disposed in an electric vehicle to power the electric vehicle. The apparatus can include a battery cell arranged in the battery pack. The battery cell can have a housing that defines a cavity within the housing of the battery cell. The battery cell can have an electrolyte having a first side and a second side to transfer lithium ions between the first side and the second side. The electrolyte can be arranged within the cavity. The battery cell can have an anode disposed within the cavity along the first side of the electrolyte. The anode can be electrically coupled with a negative terminal. The battery cell can have a composite cathode disposed within the cavity along the second side of the electrolyte. The composite cathode can be electrically coupled with a positive terminal. The composite cathode can include a lithium nickel cobalt aluminum oxide (NCA) material and a lithium nickel manganese cobalt oxide (NCM) material.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is an isometric cross-sectional perspective of an example battery cell for powering electric vehicles;

FIG. 2 is a cross-sectional view of an example battery cell for powering electric vehicles;

FIG. 3 is a graph of specific capacities of charge and discharge cycles of an example cathode with lithium nickel manganese cobalt oxide (NCM) material;

FIG. 4 is a graph of specific capacities of charge and discharge cycles of an example cathode with lithium nickel cobalt aluminum oxide (NCA) material;

FIG. 5 is a graph of specific capacities of charge and discharge cycles of an example composite cathode with NCM and NCA materials;

FIG. 6 is a block diagram depicting a cross-sectional view of an example battery module for holding battery cells in an electric vehicle;

FIG. 7 is a block diagram depicting a top-down view of an example battery pack for holding for battery cells in an electric vehicle;

FIG. 8 is a block diagram depicting a cross-sectional view of an example electric vehicle installed with a battery pack;

FIG. 9 is a flow diagram depicting an example method of assembling battery cells for battery packs for electric vehicles; and

FIG. 10 is a flow diagram depicting an example of method of providing battery cells for battery packs for electric vehicles.

### DETAILED DESCRIPTION

Following below are more detailed descriptions of various concepts related to, and implementations of battery cells for battery packs in electric vehicles. The battery cell can be a lithium-ion battery with a composite cathode that includes lithium nickel manganese cobalt oxide (NCM) material and lithium nickel cobalt aluminum oxide (NCA) material. The various concepts introduced above and discussed in greater detail below can be implemented in any of numerous ways.

Described herein are battery cells for battery packs in electric vehicles for an automotive configuration. An automotive configuration includes a configuration, arrangement or network of electrical, electronic, mechanical or electromechanical devices within a vehicle of any type. An automotive configuration can include battery cells for battery packs in electric vehicles (EVs). EVs can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned.

Lithium-ion battery cells can be used in the electric vehicle to power the components therein. In lithium-ion battery cells, lithium ions can transfer between a positive electrode and a negative electrode during charging and discharging of the battery cell. Each component of the lithium-ion battery cell can be comprised of a lithium-based oxide material or a material suitable for receiving lithium ions. For example, the anode of the battery cell can be comprised of lithium or graphite. The cathode of the battery cell can be comprised of a lithium-based oxide material. The electrolyte arranged between the anode and cathode to divide the anode and cathode from each other and to facilitate transfer of lithium ions between the anode and cathode.

Various lithium-based oxides can be used as the material for the cathode of the lithium-ion battery cell, such as: lithium cobalt oxide (LiCoO₂ or “LCO”), lithium manganese oxide (LiMn₂O₄ or “LMO”), lithium nickel manganese cobalt oxide (LiNiₓMn_{y}Co_{z}O₂, “NCM” or “NMC”), lithium nickel cobalt aluminum oxide (LiNiCoAlO₂ or “NCA”), and lithium phosphate oxide (LiFePO₄ or “LFP”), among others. With different properties, each cathode material can have advantages and disadvantages in terms of overall performance. For example, the nickel-based layered oxide materials (e.g., NCM and NCA) can have higher specific capacity and better rate performance relative to the other materials. These nickel-based layered oxide materials, however, can also suffer from lower thermal stability, faster degradation, and poorer cycle life in comparison to the other materials.

One approach to overcome some of the shortcomings and to reach a more balance performance with higher specific capacity and enhanced stability can include blending materials to form a composite material for the cathode in the lithium-ion battery cell. In general, blended composite materials can exhibit more balanced performance than non-compound or single cathode materials individually. For instance, such composite cathode materials can include layered oxide materials (e.g., LCO, NCA, and NCM or LCO and NCM) and olivines (e.g., LFP and LMO) with properties that lie in between the individual constituent materials. But layered oxide cathode materials and olivines can suffer from low specific capacity, and may not be provide adequate power for electric vehicles. For example, the olivine composite cathode material, lithium manganese iron phosphate (LiMn_{0.8}Fe_{0.2}PO₄) can have a discharge capacity for varying cell voltages that is between the discharge capacity of the constituent lithium manganese oxide (LiMn₂O₄) and lithium phosphate oxide (LiFePO₄) materials individually. Thus, lithium manganese iron phosphate may not be sufficient for electric vehicle applications. Another approach to achieve higher specific capacity while maintaining stability can include using a nickel-based layered oxide material (NCM or NCA) coated with an insulating protective layer such as aluminum oxide (Al₂O₃) or silicon oxide (SiO₂). However, the addition of the protective layer can lead to lower rate performance of the cathode, thereby rendering the battery cell unsuitable for electric vehicle applications.

In order to achieve higher specific capacity, stable cycle life, and enhanced stability, a blended, composite material with an optimal ratio of nickel-based layered oxide materials (NCM and NCA) can be used as the cathode in the lithium-ion battery cell. Individually, NCA can have a higher specific capacity, but may be susceptible to thermal instability. NCM, on the other hand, can have higher thermal stability, but can have a lower specific capacity. By blending NCM and NCA, higher specific capacity, energy density, power performance, and thermal stability can all be achieved. The optimal ratio of the blending of NCM and NCA can range between 75-85% for NCM and 15-25% for NCA.

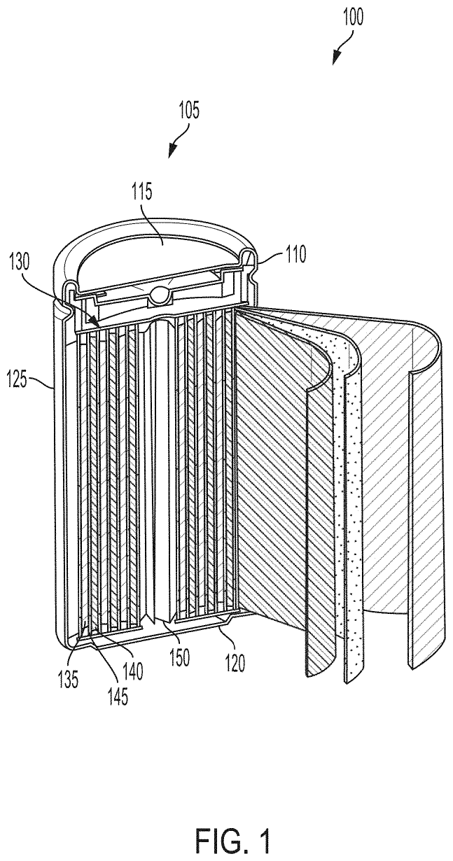

FIG. 1, among others, depicts an isometric, cross-sectional view of a battery cell 105 for powering electric vehicles. The battery cell 105 can be part of a system or an apparatus 100 that can include at least one battery pack that include battery cells 105 to power components of electric vehicles. The battery cell 105 can be an anode-free lithium-ion battery cell to power electrical components. The electrical components can be part of an electric vehicle. The electrical components powered by the battery cell 105 can be those outside of the electric vehicle settings. The battery cell 105 can include a housing 110. The housing 110 can be contained in a battery module, a battery pack, or a battery array installed in an electric vehicle. The housing 110 can be of any shape. The shape of the housing 110 can be cylindrical with a circular (e.g., as depicted), elliptical, or ovular base, among others. The shape of the housing 110 can also be prismatic with a polygonal base, such as a triangle, a square, a rectangle, a pentagon, and a hexagon, among others. The housing 110 can have a length (or height) ranging between 50 mm to 80 mm. The housing 110 can have a width (or diameter in cylindrical examples as depicted) ranging between 11 mm to 31 mm. The housing 110 can have a thickness ranging between 0.1 mm to 0.3 mm.

The housing 110 of the battery cell 105 can include one or more materials with various electrical conductivity or thermal conductivity, or a combination thereof. The electrically conductive and thermally conductive material for the housing 110 of the battery cell 105 can include a metallic material, such as aluminum, an aluminum alloy with copper, silicon, tin, magnesium, manganese or zinc (e.g., of the aluminum 1000, 4000, or 5000 series), iron, an iron-carbon alloy (e.g., steel), silver, nickel, copper, and a copper alloy, among others. The electrically insulative and thermally conductive material for the housing 110 of the battery cell 105 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The housing 110 of the battery cell 105 can have at least one lateral surface, such as a top surface 115 and a bottom surface 120. The top surface 115 can correspond to a top lateral side of the housing 110. The top surface 115 can be an integral portion of the housing 110. The top surface 115 can be separate from the housing 110, and added onto the top lateral side of the housing 110. The bottom surface 120 can correspond to a bottom lateral side of the housing 110, and can be on the opposite side of the top surface 115. The bottom surface 120 can correspond to a top lateral side of the housing 110. The bottom surface 120 can be an integral portion of the housing 110. The top surface 115 can be separate from the housing 110, and added onto the top lateral side of the housing 110. The housing 110 of the battery cell 105 can have at least one longitudinal surface, such as a sidewall 125. The sidewall 125 can extend between the top surface 115 and the bottom surface 120 of the housing 110. The sidewall 125 can have an indented portion (sometimes referred herein to as a neck or a crimped region) thereon. The top surface 115, the bottom surface 120, and the sidewall 125 can define a cavity 130 within the housing 110. The cavity 130 can correspond to an empty space, region, or volume within the housing 110 to hold content of the battery cell 105. The cavity 130 can span among the top surface 115, the bottom surface 120, and the sidewall 125 within the housing 110.

The battery cell 105 can include at least one anode layer 135 (sometimes herein generally referred to as an anode). The anode layer 135 can be situated, arranged, or otherwise disposed within the cavity 130 defined by the housing 110. At least a portion of the anode layer 135 can be in contact or flush within an inner side of the side wall 125. At least a portion of the anode layer 135 can be in contact or flush with an inner side of the bottom surface 120. The anode layer 135 can receive conventional electrical current into the battery cell 105 and output electrons during the operation of the battery cell 105 (e.g., charging or discharging of the battery cell 105). The anode layer 135 can be comprised of an active substance, such as Graphite (e.g., activated carbon or infused with conductive materials), lithium titanate (Li₄Ti₅O₁₂), or a silicon-based material (e.g., silicon carbide). The anode layer 135 can have a length (or height) ranging between 1150 to 1400 mm. The anode layer 135 can have a width ranging between 53 mm to 75 mm. The anode layer 135 can have an areal loading ranging between 6.5 mg/cm² to 10 mg/cm². The anode layer 135 can have a density ranging between 0.5 g/cm³ to 2.7 g/cm³. The anode layer 135 can have a thickness ranging between 80 μm to 110 μm.

The battery cell 105 can include at least one composite cathode layer 140 (sometimes herein generally referred to as a compound cathode layer, a compound cathode, a composite cathode, or a cathode). The composite cathode layer 140 can be situated, arranged, or otherwise disposed within the cavity 130 defined by the housing 110. At least a portion of The composite cathode layer 140 can be in contact or flush within an inner side of the side wall 125. At least a portion of The composite cathode layer 140 can be in contact or flush with an inner side of the bottom surface 120. The composite cathode layer 140 can output conventional electrical current out from the battery cell 105 and can receive electrons during the discharging of the battery cell 105. The composite cathode layer 140 can also release lithium ions during the discharging of the battery cell 105. Conversely, the composite cathode layer 140 can receive conventional electrical current into the battery cell 105 and can output electrons during the charging of the battery cell 105. The composite cathode layer 140 can receive lithium ions during the charging of the battery cell 105. The composite cathode layer 140 can have a length (or height) ranging between 1150 mm to 1400 mm. The composite cathode layer 140 can have a width ranging between 53 mm to 85 mm. The composite cathode layer 140 can have a thickness ranging between 85 μm to 115 μm. The composite cathode layer 140 can have an areal loading ranging between 12 mg/cm² to 23 mg/cm². The composite cathode layer 140 can have a density ranging between 2.5 g/cm³ to 4.7 g/cm³.

The battery cell 105 can include an electrolyte layer 145 (sometimes herein generally referred to as an electrolyte). The electrolyte layer 145 can be situated, disposed, or otherwise arranged within the cavity 130 defined by the housing 110. At least a portion of the electrolyte layer 145 can be in contact or flush within an inner side of the side wall 125. At least a portion of the electrolyte layer 145 can be in contact or flush with an inner side of the bottom surface 120. The electrolyte layer 145 can be arranged between the anode layer 135 and the composite cathode layer 140 to separate the anode layer 135 and the composite cathode layer 140. The electrolyte layer 145 can transfer ions between the anode layer 135 and the composite cathode layer 140. The electrolyte layer 145 can transfer cations from the anode layer 135 to the composite cathode layer 140 during the operation of the battery cell 105. The electrolyte layer 145 can transfer anions (e.g., lithium ions) from the composite cathode layer 140 to the anode layer 135 during the operation of the battery cell 105. The electrolyte layer 145 can have a length (or height) ranging between 1150 mm to 1400 mm. The electrolyte layer 145 can have a width ranging between 55 mm to 76 mm. The electrolyte layer 145 can have a thickness ranging between 4 μm to 17 μm.

The electrolyte layer 145 can be comprised of a liquid electrolyte material. The liquid electrolyte material can include a lithium salt dissolved in a solvent. The lithium salt for the liquid electrolyte material for the electrolyte layer 145 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 145 can be comprised of a solid electrolyte material, such as a ceramic electrolyte material, polymer electrolyte material, or a glassy electrolyte material, or among others, or any combination thereof. The ceramic electrolyte material for the electrolyte layer 145 can include, for example, lithium phosphorous oxy-nitride (LiₓPO_{y}N_{z}), lithium germanium phosphate sulfur (Li₁₀GeP₂S₁₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), among others. The polymer electrolyte material (sometimes referred herein as a hybrid or pseudo-solid state electrolyte) for electrolyte layer 145 can include, for example, polyacrylonitrile (PAN), polyethylene oxide (PEO), polymethyl-methacrylate (PMMA), and polyvinylidene fluoride (PVDF), among others. The glassy electrolyte material for the electrolyte layer 145 can include, for example, lithium sulfide-phosphor pentasulfide (Li₂S—P₂S₅), lithium sulfide-boron sulfide (Li₂S—B₂S₃), and Tin sulfide-phosphor pentasulfide (SnS—P₂S₅), among others.

The battery cell 105 can include at least one center support 150. The center support 150 can be situated, arranged, or disposed within the cavity 130 defined by the housing 110. At least a portion of the center support 150 can be in contact or flush within an inner side of the side wall 125. At least a portion of the center support 150 can be in contact or flush with an inner side of the bottom surface 120. The center support 150 can be positioned in a hollowing defined by the anode layer 135, the composite cathode layer 140, or the electrolyte layer 145. The center support 150 in the hollowing can be any structure or member to wrap around the anode layer 135, the composite cathode layer 140, and the electrolyte layer 145 in stack formation. The center support 150 can include an electrically insulative material, and can function neither as the positive terminal nor the negative terminal for the battery cell 105. The battery cell 105 can also lack or not include the center support 150.

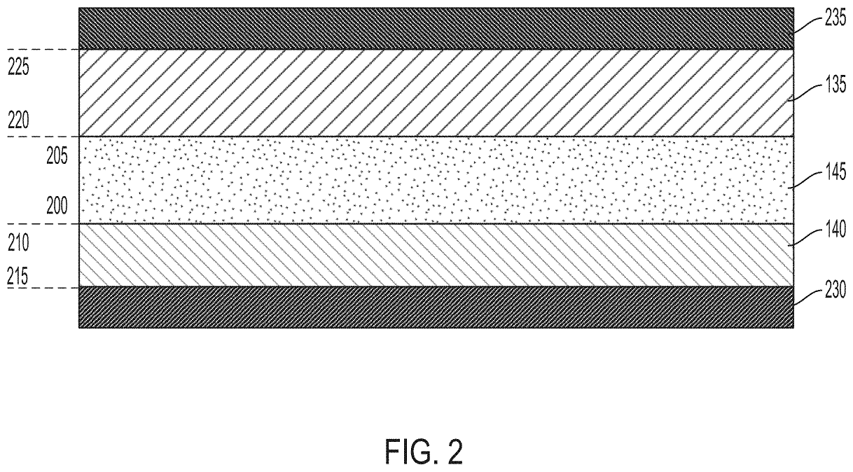

FIG. 2, among others, depicts a cross-sectional view of the battery cell 105 for powering electric vehicles. As illustrated, the at least one composite cathode layer 140, the at least one anode layer 135, and the at least one electrolyte layer 145 can be arranged within the cavity 130 in the housing 110 of the battery cell 105. The at least one composite cathode layer 140, the at least one anode layer 135, and the at least one electrolyte layer 145 can be arranged in succession, or interleaved. At least one of the composite cathode layers 140 and at least one of the anode layers 135 can be separated without a electrolyte layer 145 between the composite cathode layer 140 and the anode layer 135. At least one of the composite cathode layers 140 and at least one of the anode layers 135 can be adjacent with each other. The set of composite cathode layers 140 and the set of anode layers 135 can be electrically coupled with one another in succession. Each composite cathode layer 140 can be electrically s with one of the anode layers 135. Each anode layer 135 can be electrically coupled with one of the composite cathode layers 140. Each composite cathode layer 140, each anode layer 135, each electrolyte layer 145 can be arranged longitudinally within the cavity 130. Each composite cathode layer 140, each anode layer 135, and each electrolyte layer 145 can at least partially extend from the bottom surface 120 to the top surface 115. Each composite cathode layer 140, each anode layer 135, each electrolyte layer 145 can be arranged laterally within the cavity 130. Each composite cathode layer 140, each anode layer 135, and each electrolyte layer 145 can at least partially extend from one side wall 125 to another side wall 125.

The electrolyte layer 145 can include at least one first side 200. The first side 200 can correspond to one surface (e.g., longitudinal or lateral) of the electrolyte layer 145. The first side 200 can correspond to the surface of the electrolyte layer 145 facing the composite cathode layer 140. The composite cathode layer 140 can be disposed within the cavity 130 at least partially along the first side 200 of the electrolyte layer 145. At least a portion of the first side 200 of the electrolyte layer 145 can be in contact or flush with at least one side of the composite cathode layer 140. The electrolyte layer 145 can be electrically coupled with the composite cathode layer 140 via the first side 200. During operation of the battery cell 105 (e.g., charging or discharging), the electrolyte layer 145 can receive lithium material from the composite cathode layer 140 via the first side 200. The lithium material released by the composite cathode layer 140 can move as cations through the electrolyte layer 145 toward the anode layer 135 on the other side of the electrolyte layer 145.

The electrolyte layer 145 can include at least one second side 205. The second side 205 can correspond to one surface (e.g., longitudinal or lateral) of the electrolyte layer 145. The second side 205 can be on the opposite side as the first side 200. The second side 205 can correspond to the surface facing the anode layer 135. The anode layer 135 can be disposed within the cavity 130 at least partially along the second side 205 of the electrolyte layer 145. At least a portion of the second side 205 of the electrolyte layer 145 can be in contact or flush with at least one side of the anode layer 135. During operation of the battery cell 105 (e.g., charging or discharging), the electrolyte layer 145 can transfer lithium material from the composite cathode layer 140 to the anode layer 135 via the second side 205.

The composite cathode layer 140 can include at least one first side 210. The first side 210 can correspond to one surface (e.g., longitudinal or lateral) of the composite cathode layer 140. The first side 210 of the composite cathode layer 140 can face the first side 200 of the electrolyte layer 145. At least a portion of the first side 210 of the composite cathode layer 140 can be in contact or flush with at least a portion of the first side 200 of the electrolyte layer 145. The first side 210 of the composite cathode layer 140 can interface with the first side 200 of the electrolyte layer 145. The composite cathode layer 140 can be electrically coupled with the electrolyte layer 145 via the first side 210. During operation of the battery cell 105 (e.g., charging or discharging), the composite cathode layer 140 can release lithium material into the electrolyte layer 145 via the first side 210.

In addition, the composite cathode layer 140 can include at least one second side 215. The second side 215 can correspond to one surface (e.g., longitudinal or lateral) of the composite cathode layer 140. The second side 215 can be opposite of the first side 210 on the composite cathode layer 140. During discharging of the battery cell 105, the composite cathode layer 140 can receive electrons through the second side 215 and release conventional electrical current via the second side 215. During charging of the battery cell 105, the composite cathode layer 140 can release electrons through the second side 215 and can receive conventional electrical current via the second side 215.

The anode layer 135 can include at least one first side 220. The first side 220 can correspond to one surface (e.g., longitudinal or lateral) of the anode layer 135. The first side 220 of the anode layer 135 can face the second side 205 of the electrolyte layer 145. At least a portion of the first side 220 of the anode layer 135 can be in contact or flush with at least a portion of the second side 205 of the electrolyte layer 145. The first side 220 of the anode layer 135 can interface with the second side 205 of the electrolyte layer 145. The anode layer 135 can be electrically coupled with the electrolyte layer 145 via the first side 220. During operation of the battery cell 105 (e.g., charging or discharging), the anode layer 135 can receive the lithium material released by the composite cathode layer 140 from the electrolyte layer 145 via the first side 220.

Furthermore, the anode layer 135 can include at least one second side 225. The second side 225 can be opposite of the first side 220 on the anode layer 135. During discharging of the battery cell 105, the anode layer 135 can release electrons through the second side 225 and receive conventional electrical current via the second side 225. Conversely, during charging of the battery cell 105, the anode layer 135 can receive electrons from the second side 225 and release conventional electrical current via the second side 225.

The battery cell 105 can include at least one positive conductive layer 230 (sometimes referred herein as a positive conductive plate or sheet). The positive conductive layer 230 can correspond to or define a positive terminal for the battery cell 105. The positive conductive layer 230 can be disposed or arranged within the cavity 130 in the housing 110 of the battery cell 105 along the second side 215 of the composite cathode layer 140. At least a portion of the positive conductive layer 230 can be in contact or flush with at least a portion of the second side 215 of the composite cathode layer 140. The positive conductive layer 230 can interface with the composite cathode layer 140 along the second side 215. The positive conductive layer 230 can be electrically coupled with the composite cathode layer 140 via the second side 215. Through the positive conductive layer 230, the composite cathode layer 140 can be electrically coupled with the positive terminal for the battery cell 105.

The positive conductive layer 230 can be comprised of an electrically conductive material. The electrically conductive material for the positive conductive layer 230 can include a metallic material, such as nickel, copper, an aluminum alloy with copper, silicon, tin, magnesium, manganese or zinc (e.g., of the aluminum 1000, 4000, or 5000 series), iron, an iron-carbon alloy (e.g., steel), silver, and a copper alloy, among others. The electrically conductive material for the positive conductive layer 230 can also include carbon-based materials, such as graphite and carbon fiber, among others.

During discharging of the battery cell 105, the positive conductive layer 230 can receive electrons into the battery cell 105 and release conventional electrical current from the battery cell 105. Conversely, during charging of the battery cell 105, the positive conductive layer 230 can release electrons from the battery cell 105 and receive conventional electrical current into the battery cell 105. The positive conductive layer 230 can have a length (or height) ranging between 1100 mm to 1350 mm. The positive conductive layer 230 can have a width ranging between 52 mm to 74 mm. The positive conductive layer 230 can have a thickness ranging between 4 μm to 17 μm.

The battery cell 105 can include at least one negative conductive layer 235 (sometimes referred herein as a negative conductive plate or sheet). The negative conductive layer 235 can correspond to or define a negative terminal for the battery cell 105. The negative conductive layer 235 can be of the opposite polarity as the positive conductive layer 230. The negative conductive layer 235 can be disposed or arranged within the cavity 130 in the housing 110 of the battery cell 105 along the second side 225 of the anode layer 135. At least a portion of the negative conductive layer 235 can be in contact or flush with at least a portion of the second side 225 of the anode layer 135. The negative conductive layer 235 can interface with the anode layer 135 along the second side 225. The negative conductive layer 235 can be electrically coupled with the anode layer 135 via the second side 225. Through the negative conductive layer 235, the anode layer 135 can be electrically coupled with the negative terminal for the battery cell 105.

The negative conductive layer 235 can be comprised of an electrically conductive material. The electrically conductive material for the negative conductive layer 235 can include a metallic material, such as nickel, copper, an aluminum alloy with copper, silicon, tin, magnesium, manganese or zinc (e.g., of the aluminum 1000, 4000, or 5000 series), iron, an iron-carbon alloy (e.g., steel), silver, and a copper alloy, among others. The electrically conductive material for the negative conductive layer 235 can also include carbon-based materials, such as graphite and carbon fiber, among others.

During discharging of the battery cell 105, the negative conductive layer 235 can release electrons from the battery cell 105 and receive conventional electrical current from the battery cell 105. Conversely, during charging of the battery cell 105, the negative conductive layer 235 can receive electrons from the battery cell 105 and release conventional electrical current into the battery cell 105. The negative conductive layer 235 can have a length (or height) ranging between 1100 mm to 1350 mm. The negative conductive layer 235 can have a width ranging between 52 mm to 74 mm. The negative conductive layer 235 can have a thickness ranging between 5 μm to 17 μm.

Individually, lithium-based intercalated materials used for cathodes in lithium-ion battery cells (e.g., the battery cell 105) can have differing operating characteristics (sometimes referred herein as properties, profiles, or attributes), such as a specific capacity, an energy density, a rate performance, a charge retention, a thermal stability, and a lifespan, among others. The specify capacity can define an amount of current that can be withdrawn from the battery cell over time by mass (measured as milliamp-hour per grams (mAh/g) or milliwatt-hour per grams (mWh/g)). The energy density can define a ratio of energy that can be stored on the battery cell by volume (measured as watt-hours per liter (Wh/L) or watt-hours per kilogram (Wh/g)). The rate performance can define an amount of current that can be drawn over time from the battery cell per rated capacity (measured in C-rates). The charge retention can define a remaining capacity after a given amount of time over a cycle time (including fully charging and discharging) (measured in percentage). The thermal stability can define a maximum temperature or heat that the battery cell can undergo prior to catastrophic failure (e.g., thermal runaway conditions). The lifespan can define an expected amount of time that the battery cell is operated (measured in years, days, or hours, among others).

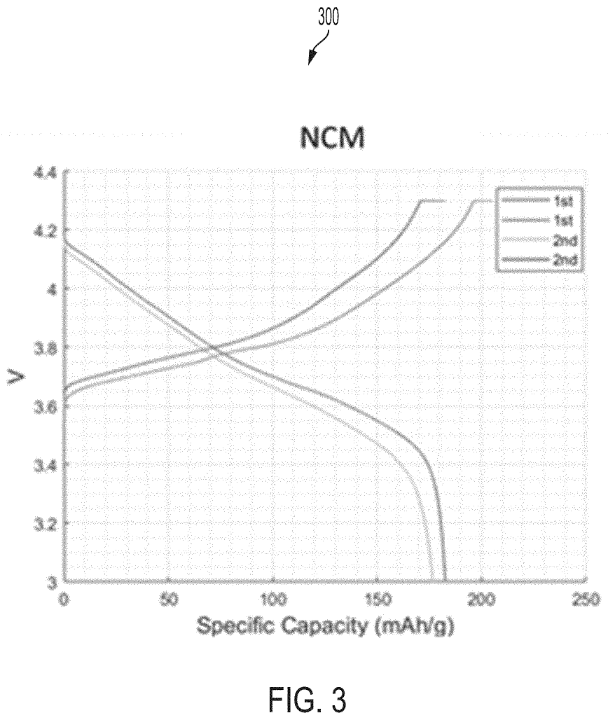

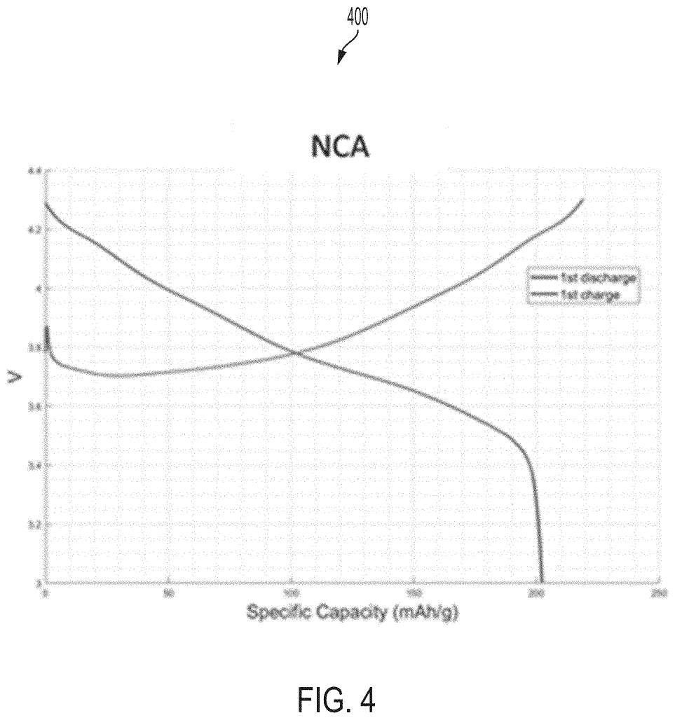

Among the intercalated cathode materials, lithium nickel cobalt aluminum oxide (NCA) and lithium nickel manganese cobalt oxide (NCM) can have relative higher specific capacities and rate performance in comparison to other materials, such as lithium cobalt (LCO), lithium manganese oxide (LMO), and lithium phosphate oxide (LFP). With higher specific capacities and rate performance compared to the other cathode materials, NCA or NCM as cathode materials can provide adequate power in electric vehicle applications. NCM and NCA can have differing properties and operating characteristics, with neither NCM nor NCA having a prevailing advantage relative to each other when used as cathodes individually. For example, a lithium-ion battery cell with NCA material as a cathode can have higher specific capacity than a battery cell with NCA during charging and discharging. FIG. 3 depicts a graph 300 of specific capacities of a single charge and discharge cycle of a battery cell with the NCM material as the cathode. FIG. 4 depicts a graph 400 specific capacities of a first and a second charge and discharge cycle of a battery cell with the NCA material as the cathode. Juxtaposing the graphs 300 and 400, the cathode with NCA material can have a higher specific capacity than the cathode with NCM material during charging and discharging cycles. Conversely, a lithium-ion battery cell with NCM material that contains slightly less nickel as the cathode can have better thermal stability than a cell with NCA as the cathode. As a result, battery cells with NCA material as cathodes can suffer a higher likelihood of heat-related failures and faster degradation relative to battery cells with NCM material as the cathode.

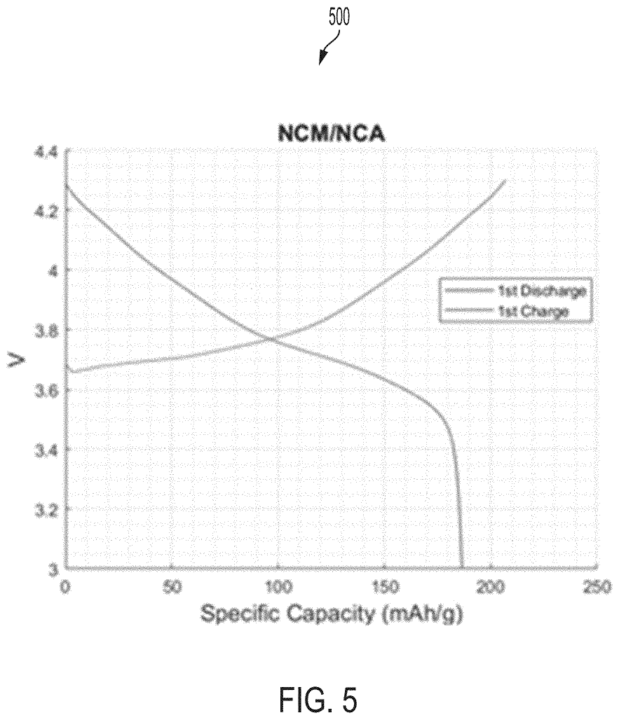

To achieve a more balanced performance relative to using NCA or NCM materials separately, the composite cathode layer 140 can be comprised of or can include the NCA material and the NCM material. FIG. 5 depicts a graph 500 of specific capacities of one discharge and charge cycle of the battery cell 105 having the composite cathode layer 140 comprised of the NCA and NCM materials. Comparing the graphs 300, 400, and 500, the battery cell 105 having the composite cathode layer 140 with both NCA and NCM materials can have a similar specific capacity profile as the battery cells with NCA or NCM material individually.

The NCA material and the NCM material may be combined using any number of fabrication techniques to synthesize, create, or otherwise form the composite cathode layer 104 of the battery cell 105. The fabrication techniques to form the composite cathode layer 104 can include, for example, die casting (or molding), vacuum deposition techniques (e.g., chemical vapor deposition (CVD), molecular vapor deposition (MVD), or physical vapor deposition (PVD)), molecular-beam epitaxy (MBE), mixing, and coating (e.g., spin coating, surface treatment, or surface modification), or any combination thereof, among others. For example, the composite cathode layer 104 can be fabricated using a planetary mixer with ½ horsepower output and a mixing speed of 20 rpm to 30 rpm for the mixer and 400 rpm to 700 rpm for the dispenser. The materials for the composite cathode layer 104 can be divided into 4 to 5 piles and added to the planetary mixer to be into slurry. The resultant slurry can be degassed in a vacuum prior to coating. Once complete, the resultant composite can be pressed by a roll-to-roll pressure controlled rolling press and coated using a slot die coater.

The combination of the NCA material and the NCM material for the composite cathode layer 140 can include various types of composites. The composite cathode layer 140 can include a blended mixture of the NCA material and the NCM material. For example, the blended mixture can include an substantially evenly distribution (e.g., within 15%) of the NCA material and the NCM material throughout the composite cathode layer 140. The blended mixture of the NCA material and the NCM material for the composite cathode layer 140 can be formed using any number of fabrication techniques.

The composite cathode layer 140 can include a spatially graded composite of the NCA material and the NCM material. The spatially graded composite can have a varying distribution of the NCA material and the NCM material within the composite cathode layer 140. For example, the composite cathode layer 140 toward the first side 210 can have a higher concentration of the NCA material than NCM material and towards the second side 215 have a higher concentration of the NCM material than the NCA material. The spatially graded composite of the NCA material and the NCM material for the composite cathode layer 140 can be formed using any number of fabrication techniques.

The composite cathode layer 140 can be, correspond to, or have a surface coated structure (also referred herein as a surface treated or modified structure) comprised of the NCA material and the NCM material. For example, an inner portion of the composite cathode layer 140 between the first side 210 and the second side 215 can be comprised of the NCA material and an outer portion of the composite cathode layer 140 along the first side 210 and the second side 215 can be comprised of the NCM material, or vice-versa. The surface coated composite of the NCA material and the NCM material for the composite cathode layer 140 formed using any number of fabrication techniques, such as the previous mentioned coating techniques.

The composite cathode layer 140 can be comprised of or can have a predefined proportion corresponding to the NCA material and a predefined proportion corresponding to the NCM material. The proportions of the NCA material and the NCM material can be interspersed, distributed, or intermixed throughout the composite cathode layer 140. The predefined proportion corresponding to the NCA material can measure or define a portion, a fraction, or a percentage by weight (or by mass) of an amount of the NCA material within the composite cathode layer 140. The amount of the NCA material can range between 80%-40% in weight. Likewise, the predefined proportion corresponding to the NCM material can measure or define a portion, a fraction, or a percentage by weight (or by mass) of an amount of the NCM material within the composite cathode layer 140. The amount of the NCM material can range between 20%-60% in weight. In addition, the proportions of the NCA material and the NCM material can be defined relative to each other as a predefined ratio between the NCA material and the NCM material in the composite cathode layer 140. The ratio can measure or define a relative amounts of the NCA material and of the NCM material by weight (or by mass) within the composite cathode layer 140. The total active material weight in the composite cathode layer 140 can range between 12 mg/cm² to 23 mg/cm². Together, the NCA material and the NCM material together can constitute 90-100% of the composite cathode layer 140 by weight (or by mass). The remainder of the composite cathode layer 140 can include other materials. At least a portion (e.g., 0-10% by weight) of the remainder of the composite cathode layer 140 can correspond to other materials, such as a binding material (e.g., polyvinylidene difluoride (PVDF)) and conductive materials (e.g., graphite such as super-P and carbon nanotube (CNT)).

The proportions of the NCA material and the NCM material within the composite cathode layer 140 can be apportioned, allocated, or otherwise set to attain one or more target operating characteristics for the composite cathode layer 140 or the battery cell 105 as a whole. By extension, the ratio between the amount of NCA material and the amount of the NCM material in the composite cathode layer 140 can also be set to attain the one or more target operating characteristics. The setting of the proportions corresponding to the NCA material and the NCM material (or the ratio between the two materials) in the composite cathode layer 140 can be performed during the fabrication of the composite cathode layer 140. The target operating characteristics (sometimes herein referred as “preconfigured,” “predefined,” or “preset” operating characteristics) can include: a target specific capacity, a target energy density, a target rate performance, a target charge retention, a target thermal stability, and a target lifespan, among others.

In addition, contents of constituent elements within the NCA material or the NCM material in the composite cathode layer 140 can be apportioned, allocated, or otherwise set to attain one or more target operating characteristics for the composite cathode layer 140 and the battery cell 105. The constituent elements for the NCA material can include: lithium, nickel, cobalt, and aluminum, and oxide. The constituent elements for the NCM material can include: lithium, nickel, cobalt, manganese, and oxide. Setting or adjusting the content of any of the constituent elements can yield in a different operating characteristic for the NCA material or the NCM material in the composite cathode layer 140. For example, the nickel content of NCM material of the composite cathode layer 140 can be set to attain a target specific capacity and target energy density. The specific capacity of NCM materials can linearly vary depending on nickel content. NCM materials with higher nickel content may have higher specific capacity than NCM materials with lower nickel. For example, “NMC811” (80% nickel, 10% manganese, and 10% cobalt) having a higher specific capacity than “NMC 333” (⅓ nickel, ⅓ manganese, and ⅓ cobalt). Thus, a composite cathode layer 140 using 80% nickel content in the NMC material can have a higher specific capacity than a composite cathode layer 140 using 33% nickel content in the NMC material.

The composite cathode layer 140 (or the battery cell 105 housing the composite cathode layer 140) can result in or yield varying operating characteristics with different proportions of the NCA material and the NCM material. The operating characteristics may not vary in a linearly proportional manner (e.g., directly or inversely proportional) with different proportions of the NCA material and the NCM material in the composite cathode layer 140. To measure and determine the operating characteristics of different proportions of the NCA material and the NCM material in the composite cathode layer 140, one or more tests may be carried out. An example of one such test is detailed herein below.

Table 1 enumerates six samples of battery cells 105 having composite cathode layers 140 with varying compositions of the NCA material and the NCM material used in the experiment. Besides the compositions of the NCA material and the NCM materials, all other components of the battery cell 105 in each sample can be maintained the same. The battery cell 105 in each sample can be a coin cell (or a button cell) with a diameter (e.g., 10 mm to 30 mm) wider than height (e.g., 22 mm to 42 mm) or thickness (e.g., 22 mm to 42 mm). The electrolyte layer 145 of the battery cell 105 in each sample can be include a separator holding a liquid electrolyte material. The separator can include a polypropylene (PP) and polyethylene (PE) material. The liquid electrolyte material can include a lithium hexafluorophosphate (LiPF6) salt dissolved in ethylene carbonate and dimethyl carbonate (EC/DMC).

| | NCM/NCA | | | | | |
|---|---|---|---|---|---|---|
| | Percentages | | SuperP/ | | Loading | Density |
| Sample | (by Weight) | | CNT | PVDF | (mg/cm²) | (g/cm³) |
| 1 | 85-75 | 15-25 | <3% | <3% | 15-25 | 3.4-3.7 |
| 2 | 60-40 | 40-60 | | | | |
| 3 | 15-25 | 85-75 | | | | |
| 4 | 0-5 | 100-95 | | | | |
| 5 | 70-55 | 30-45 | | | | |
| 6 | 30-50 | 70-50 | | | | |

Table 2 enumerates the composition of the anode layer 135 of the battery cell 105 in each sample:

| Material | Composition |
|---|---|
| Graphite and Silicon carbide | 90%-98% |
| Carboxymethyl Cellulose | 5%-1% |
| (CMC) | |
| Styrene-Butadiene Rubber | 5%-1% |
| (SBR) | |

As listed in Table 1, the compositions of the NCM and the NCA materials in the composite cathode layer 140 can differ among the samples. The composite cathode layer 140 of the first sample can be comprised of 85-75% in NCM material by weight and 15-25% in NCA material by weight. The composite cathode layer 140 of the second sample can be comprised of 60-40% in NCM material by weight and 40-60% in NCA material by weight. The composite cathode layer 140 of the third sample can be comprised of 15-25% in NCM material by weight and 85-75% in NCA material by weight. The composite cathode layer 140 of the fourth sample can be comprised of 0-5% in NCM material by weight and 100-95% in NCA material by weight. The composite cathode layer 140 of the fifth sample can be comprised of 70-55% in NCM material by weight and 30-45% in NCA material by weight. The composite cathode layer 140 of the sixth sample can be comprised of 30-50% in NCM material by weight and 70-80% in NCA material by weight. The composite cathode layers 140 in all six samples can have less than 3% in Super-P carbon nanotube (CNT) by weight and can have less than 3% in polyvinylidene fluoride (PVDF). Furthermore, the composite cathode layers 140 in all the samples can have an areal load ranging between 15-25 mg/cm² and a density ranging between 3.4-3.7 g/cm³.

Table 3 lists testing parameters applied to all six samples of the composite cathode layers 140. The test protocols can vary in charge or discharge rate relative to capacity (also referred herein as a C-rate or C).

| Voltage Window (V) | Test Protocol |
|---|---|
| 3.0-4.3 | C/20 |
| | C/10 × 2 |
| | C/5 × 2 |
| | C/2 × 2 |
| | 1C, 2C, 3C, 5C × 5 each |
| | (Delithiation 1C) |

The voltage window for the battery cells 105 in all six samples can range between 3.0-4.3 V. At each test protocol, various operating characteristics of the six samples of the battery cells 105 can be measured. The measured operating characteristics can include rate performance (e.g., charge or discharge rate), and capacity retention, among others.

Table 4 shows the average discharge capacity at C/20 and capacity retention at 5 C measured from the battery cells 105 in all six samples.

| | Average Discharge | Capacity Retention |
|---|---|---|
| Sample | Capacity at C/20 (mAh/g) | at 5C |
| 1 | 191.3 | 78.9% |
| 2 | 194.9 | 77.6% |
| 3 | 200.3 | 68.0% |
| 4 | 203.2 | 71.4% |
| 5 | 193.8 | 52.9% |
| 6 | 199.4 | 81.2% |

From the measurements, the battery cell 105 of the first sample (85-75% in NCM and 15-25% in NCA) can have an average discharge capacity of 191.3 at C/20 and capacity retention of 78.9% at 5 C. The battery cell 105 of the second sample (60-40% in NCM and 40-60% in NCA) can have an average discharge capacity of 194.9 at C/20 and capacity retention of 77.6% at 5 C. The battery cell 105 of the third sample (15-25% in NCM and 85-75% in NCA) can have an average discharge capacity of 200.3 at C/20 and capacity retention of 68.0% at 5 C. The battery cell 105 of the fourth sample (0-5% in NCM and 100-95% in NCA) can have an average discharge capacity of 203.2 at C/20 and capacity retention of 71.4% at 5 C. The battery cell 105 of the fifth sample (70-55% in NCM and 30-45% in NCA) can have an average discharge capacity of 193.8 at C/20 and capacity retention of 52.9% at 5 C. The battery cell 105 of the sixty sample (30-50% in NCM and 70-50% in NCA) can have an average discharge capacity of 199.4 at C/20 and capacity retention of 81.2% at 5 C.

As seen in the results above, the discharge capacity can increase with higher content of NCA material in the composite cathode layer 140 of the battery cell 105. However, the rate performance may not increase monotonically with the NCA content in the composite cathode layer 140 of the battery cell 105. As a result, the battery cells 105 of the first sample (with 85-75% in NCM material and 15-25% in NCA material by weight in the composite cathode layer 140) and the sixth sample (with 30-50% in NCM material and 70-50% in NCA material by weight in the composite cathode layer 140) can have a balanced performance in terms of discharge capacity and rate performance. For optimal discharge capacity and rate performance, the proportions of the materials in the composite cathode layer 140 can be set to: (1) 85-75% in the NCM material and 15-25% in the NCA material by weight or (2) 30-50% in the NCM material and 70-50% in the NCA material by weight. While not list in the table above, the battery cell 105 of the first sample can have higher thermal stability and longer lifespan, due to the higher proportion of the NCM material than the proportion of the NCA material in the composite cathode layer 140. With consideration of higher thermal stability and longer lifespan, the proportions of the materials in the composite cathode layer 140 can be set to 85-75% in the NCM material and 15-25% in the NCA material by weight.

Additional testing can be performed to measure other operating characteristics of the battery cell 105 with different compositions of the composite cathode layer 140. For example, heat may be applied to a battery cell 105 to determine the thermal stability of the composite cathode layer 140 with the given compositions of the NCA material and the NCM material. A temperature at which thermal runoff or a catastrophic failure of the battery cell 105 can be measured in determining the thermal stability of the composite cathode layer 140.

By setting the proportions of the NCA material and the NCM material and the contents of the constituent elements, the composite cathode layer 140 can attain the one or more target operating characteristics. In this manner, the battery cell 105 with the composite cathode layer 140 can exhibit the high specific capacity of the NCA material, thereby making the battery cell 105 suitable for electric vehicle applications. At the same time, the battery cell 105 with the composite cathode layer 140 can possess the thermal stability of the NCM material, allowing the battery cell 105 to have a longer utility.

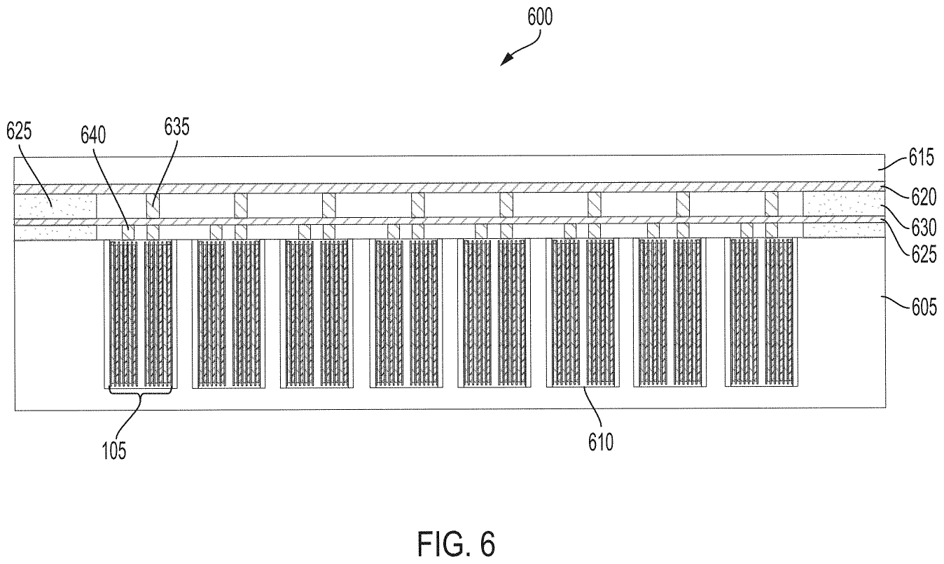

FIG. 6, among others, depicts a cross-section view of a battery module 600 to hold a set of battery cells 105 in an electric vehicle. The battery module 600 can be part of the system or apparatus 100. The battery module 600 can be of any shape. The shape of the battery module 600 can be cylindrical with a circular, elliptical, or ovular base, among others. The shape of the battery module 600 can also be prismatic with a polygonal base, such as a triangle, a square, a rectangle (e.g., as depicted), a pentagon, and a hexagon, among others. The battery module 600 can have a length ranging between 10 cm to 200 cm. The battery module 600 can have a width ranging between 10 cm to 200 cm. The battery module 600 can have a height ranging between 65 mm to 100 cm.

The battery module 600 can include at least one battery case 605 and a capping element 615. The battery case 605 can be separated from the capping element 615. The battery case 605 can include or define a set of holders 610. Each holder 610 can be or include a hollowing or a hollow portion defined by the battery case 605. Each holder 610 can house, contain, store, or hold a battery cell 105. The battery case 605 can include at least one electrically or thermally conductive material, or combinations thereof. Between the battery case 605 and the capping element 615, the battery module 600 can include at least one positive current collector 620, at least one negative current collector 625, and at least one electrically insulative layer 630. The positive current collector 620 and the negative current collector 625 can each include an electrically conductive material to provide electrical power to other electrical components in the electric vehicle. The positive current collector 620 (sometimes referred herein as a positive busbar) can be connected or otherwise electrically coupled with the positive conductive layer 230 of each battery cell 105 housed in the set of holders 610 via a bonding element 635. One end of the bonding element 635 can be bonded, welded, connected, attached, or otherwise electrically coupled to the positive conductive layer 230 of the battery cell 105. The negative current collector 625 (sometimes referred herein as a negative busbar) can be connected or otherwise electrically coupled with the negative conductive layer 235 of each battery cell 105 housed in the set of holders 610 via a bonding element 640. The bonding element 640 can be bonded, welded, connected, attached, or otherwise electrically coupled to the negative conductive layer 235 of the battery cell 105.

The positive current collector 620 and the negative current collector 625 can be separated from each other by the electrically insulative layer 630. The electrically insulative layer 630 can include spacing to pass or fit the positive bonding element 635 connected to the positive current collector 620 and the negative bonding element 640 connected to the negative current collector 625. The electrically insulative layer 630 can partially or fully span the volume defined by the battery case 605 and the capping element 615. A top plane of the electrically insulative layer 630 can be in contact or be flush with a bottom plane of the capping element 615. A bottom plane of the electrically insulative layer 630 can be in contact or be flush with a top plane of the battery case 605. The electrically insulative layer 630 can include any electrically insulative material or dielectric material, such as air, nitrogen, sulfur hexafluoride (SF₆), ceramic, glass, and plastic (e.g., polysiloxane), among others to separate the positive current collector 620 from the negative current collector 625.

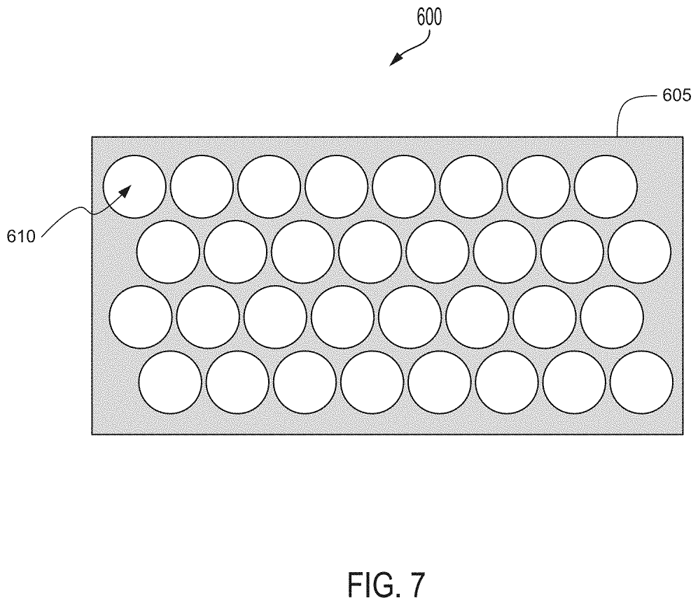

FIG. 7, among others, depicts a top-down view of a battery module 600 to a hold a plurality of battery cells 105 in an electric vehicle. The battery module 600 can define or include a set of holders 610. The shape of each holder 610 can match a shape of the housing 110 of the battery cell 105. The shape of each holder 610 can be cylindrical with a circular (e.g., as depicted), elliptical, or ovular base, among others. The shape of each holder 610 can also be prismatic with a polygonal base, such as a triangle, a square, a rectangle, a pentagon, and a hexagon, among others. The shapes of each holder 610 can vary or can be uniform throughout the battery module 600. For example, some holders 610 can be hexagonal in shape, whereas other holders can be circular in shape. The dimensions of each holder 610 can be larger than the dimensions of the battery cell 105 housed therein. Each holder 610 can have a length ranging between 10 mm to 300 mm. Each holder 610 can have a width ranging between 10 mm to 300 mm. Each holder 610 can have a height (or depth) ranging between 65 mm to 100 cm.

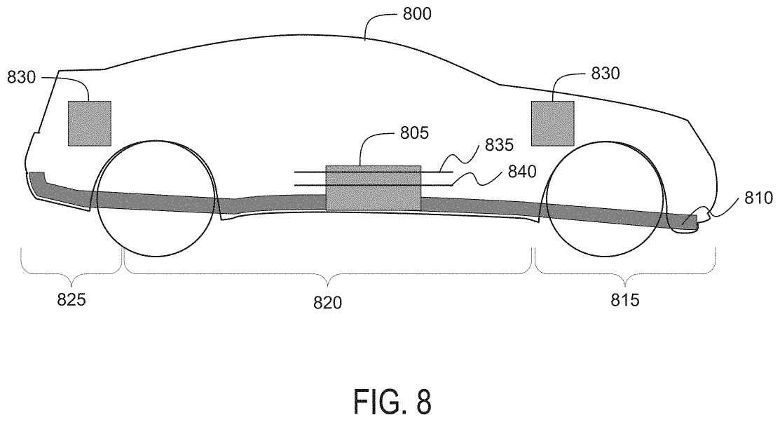

FIG. 8, among others, depicts a cross-section view of an electric vehicle 800 installed with a battery pack 805. The apparatus to power the electric vehicle 800 can include at least one battery cell 105, at least one battery module 600, and at least one battery pack 805, including the components thereof. The battery pack 805 can include one or more than one battery modules, for example. The electric vehicle 800 can be an electric automobile (e.g., as depicted), hybrid, a motorcycle, a scooter, a passenger vehicle, a passenger or commercial truck, and another type of vehicle such as sea or air transport vehicles, a plane, a helicopter, a submarine, a boat, or a drone, among others. The electric vehicle 800 can include at least one battery pack 805. The battery pack 805 can be part of the system or apparatus 100. The battery pack 805 can house, contain, or otherwise include a set of battery modules 700. The number of battery modules 700 in the battery pack 805 can range between. The battery pack 805 can be of any shape. The shape of battery pack 805 can be cylindrical with a circular, elliptical, or ovular base, among others. The shape of battery pack 805 can also be prismatic with a polygonal base, such as a triangle, a square, a rectangle (e.g., as depicted), a pentagon, and a hexagon, among others. The battery pack 805 can have a length ranging between 80 cm to 600 cm. The battery pack 805 can have a width ranging between 50 cm to 400 cm. The battery pack 805 can have a height ranging between 70 mm to 800 mm.

The electric vehicle 800 can include at least one chassis 810 (e.g., a frame, internal frame, or support structure). The chassis 810 can support various components of the electric vehicle 800. The chassis 810 can span a front portion 815 (e.g., a hood or bonnet portion), a body portion 820, and a rear portion 825 (e.g., a trunk portion) of the electric vehicle 800. The battery pack 805 can be installed or placed within the electric vehicle 800. The battery pack 805 can be installed on the chassis 810 of the electric vehicle 800 within the front portion 815, the body portion 820 (as depicted in FIG. 8), or the rear portion 825.

The electric vehicle 800 can include one or more components 830. The one or more components 830 can include an electric engine, an entertainment system (e.g., a radio, display screen, and sound system), on-board diagnostics system, and electric control units (ECUs) (e.g., an engine control module, a transmission control module, a brake control module, and a body control module), among others. The one or more components 830 can be installed in the front portion 815, the body portion 820, or the rear portion 825 of the electric vehicle 800. The battery pack 805 installed in the electric vehicle 800 can provide electrical power to the one or more components 830 via at least one positive current collector 835 and at least one negative current collector 840. The positive current collector 835 and the negative current collector 840 can be connected or otherwise be electrically coupled to other electrical components of the electric vehicle 800 to provide electrical power. The positive current collector 835 (e.g., a positive busbar) can be connected or otherwise electrically coupled with each positive current collector 835 of each battery module 600 in the battery pack 805. The negative current collector 840 (e.g., a negative busbar) can be connected or otherwise electrically coupled with each negative current collector 625 of each battery module 600 in the battery pack 805.

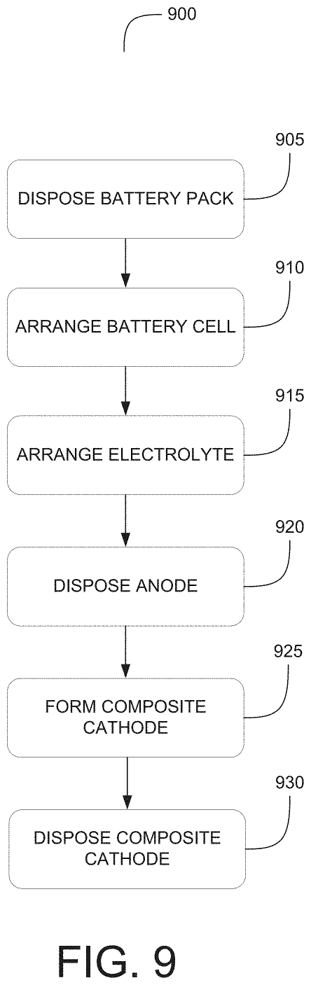

FIG. 9, among others, depicts a method 900 of assembling battery cells to power electric vehicles. The functionalities of the method 900 can be implemented or performed using any of the systems, apparatuses, or battery cells detailed above in conjunction with FIGS. 1-8. The method 900 can include disposing a battery pack 805 (ACT 905). The battery pack 805 can be installed, arranged, or otherwise disposed in an electric vehicle 800. The battery pack 805 can house, contain, or include a set of battery modules 600. The battery pack 805 can store electrical power for one or more components 830 of the electric vehicle 800. The battery pack 805 can provide electrical power to the one or more components 830 via a positive current collector 835 and a negative current collector 840.

The method 900 can include arranging a battery cell 105 (ACT 910). The battery cell 105 can be a lithium-ion battery cell. The battery cell 105 can be stored or contained within a holder 610 of the battery module 600 included in the battery pack 805. The battery cell 105 can include a housing 110. The housing 110 can be formed from a cylindrical casing with a circular, ovular, or elliptical base or from a prismatic casing with a polygonal base. The housing 110 can include a top surface 115, a bottom surface 120, and a sidewall 125. The housing 110 can have a cavity 130 to contain contents of the battery cell 105. The cavity 130 within the housing 110 can be defined by the top surface 115, the bottom surface 120, and the sidewall 125.

The method 900 can include arranging a electrolyte layer 145 (ACT 915). The electrolyte layer 145 can be comprised of a solid or liquid electrolyte material. The material for the electrolyte layer 145 can be formed using deposition techniques, such as chemical deposition (e.g., chemical vapor deposition (CVD) or atomic layer deposition (ALD)) or physical deposition (e.g., molecular beam epitaxy (MBE) or physical vapor deposition (PVD)). For liquid electrolytes, the material for the electrolyte layer 145 can be doused or dissolved in an organic solvent. The electrolyte layer 145 can be fed, inserted, or otherwise placed into the cavity 130 of the housing 110 for the battery cell 105. The electrolyte layer 145 can at least partially span between the top surface 115, the bottom surface 120, and the sidewall 125 of the housing 110 for the battery cell 105.

The method 900 can include disposing an anode layer 135 (ACT 920). The anode layer 135 can be placed or inserted into the cavity 130 of the housing 110 for the battery cell 105. The anode layer 135 can be situated at least partially along the first side 200 of the electrolyte layer 145. The anode layer 135 can receive conventional electrical current into the battery cell 105. The anode layer 135 can be electrically coupled with the negative conductive layer 235 also inserted into the cavity 130 in the housing 110 of the battery cell 105. The anode layer 135 can be formed using deposition techniques, such as chemical deposition (e.g., chemical vapor deposition (CVD) or atomic layer deposition (ALD)) or physical deposition (e.g., molecular beam epitaxy (MBE) or physical vapor deposition (PVD)). The anode layer 135 can at least partially span between the top surface 115, the bottom surface 120, and the sidewall 125 of the housing 110 for the battery cell 105.

The method 900 can include forming a composite cathode layer 140 (ACT 925). The composite cathode layer 140 can be comprised of a lithium nickel cobalt aluminum oxide (NCA) material and a lithium nickel manganese cobalt oxide (NCM) material. The composite cathode layer 140 can be comprised of the NCA material and the NCM material at a predefined ratio to attain a target property or operating characteristics for the composite cathode layer 140. The composite cathode layer 140 can be synthesized, created, or otherwise formed to obtain the predefined ratio using any number of fabrication techniques, such as die casting (or molding), vacuum deposition techniques (e.g., chemical vapor deposition (CVD), molecular vapor deposition (MVD), or physical vapor deposition (PVD)), molecular-beam epitaxy (MBE), and coating (e.g., spin coating, surface treatment, or surface modification), among others. The combination of the NCA material and the NCM material for the composite cathode layer 140 can include various types of composites, such as a blended mixture, a spatially graded composite, and a surface coated material, among others.

The method 900 can include disposing the composite cathode layer 140 (ACT 930). The composite cathode layer 140 can be placed or inserted into the cavity 130 of the housing 110 for the battery cell 105. The composite cathode layer 140 can be situated at least partially along the first side 200 of the electrolyte layer 145. The composite cathode layer 140 can output conventional electrical current into the battery cell 105. The composite cathode layer 140 can be electrically coupled with the positive conductive layer 230 also inserted into the cavity 130 in the housing 110 of the battery cell 105. The composite cathode layer 140 can at least partially span between the top surface 115, the bottom surface 120, and the sidewall 125 of the housing 110 for the battery cell 105.

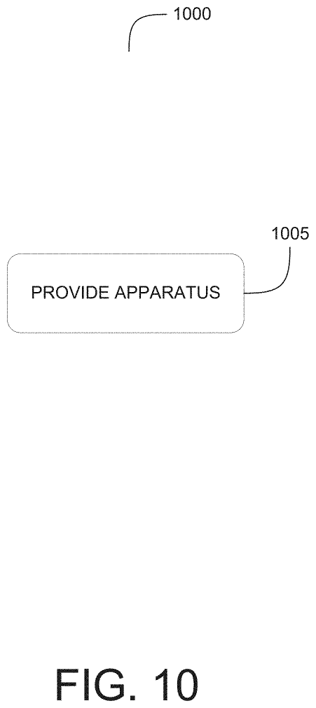

FIG. 10, among others, depicts a method 1000 of providing battery cells to power electric vehicles. The functionalities of the method 1000 can be implemented or performed using any of the systems, apparatuses, or battery cells detailed above in conjunction with FIGS. 1-11. The method 1000 can include providing an apparatus 100 (ACT 1005). The apparatus 100 can be installed in an electric vehicle 800. The apparatus 100 can include a battery pack 805 disposed in the electric vehicle 800 to power one or more components 830 of the electric vehicle 800. The battery pack 805 can include one or more battery modules 600. The apparatus 100 can include a set of battery cells 105. Each battery cell 105 can be arranged in the battery module 600. The battery cell 105 can include a housing 110. The housing 110 can include a top surface 115, a bottom surface 120, and a sidewall 125. The top surface 115, the bottom surface 120, and the sidewall 125 can define a cavity 130.

Within the cavity 130 defined by the housing 110, the battery cell 105 can have an electrolyte layer 145. The electrolyte layer 145 can have a first side 200 and a second side 205, and can transfer ions between the first side 200 and the second side 205. The battery cell 105 can have a composite cathode layer 140 disposed within the cavity 130 of the housing 110 along the first side 200 of the electrolyte layer 145. The composite cathode layer 140 can be electrically coupled with the positive terminal of the battery cell via a positive conductive layer 230. The composite cathode layer 140 can have a mixture of the NCM material and the NCA material at a predefined ratio to attain one or more target operating characteristics.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus to power electric vehicles, comprising:
a battery pack disposed in an electric vehicle to power the electric vehicle; and
a battery cell arranged in the battery pack, the battery cell having a housing that defines a cavity within the housing of the battery cell, the battery cell having:
an electrolyte having a first side and a second side to transfer lithium ions between the first side and the second side, the electrolyte arranged within the cavity;
an anode disposed within the cavity along the first side of the electrolyte, the anode electrically coupled with a negative terminal; and
a composite cathode disposed within the cavity along the second side of the electrolyte, the composite cathode electrically coupled with a positive terminal, the composite cathode comprising a lithium nickel cobalt aluminum oxide (NCA) material and a lithium nickel manganese cobalt oxide (NCM) material.

2. The apparatus of claim 1, comprising:
the composite cathode comprising a blended mixture of the NCA material and the NCM material at a predefined ratio to attain a target operating characteristic.

3. The apparatus of claim 1, comprising:
the NCA material ranging between 75% to 85% of the composite cathode in weight and the NCM material ranging between 15% to 25% of the composite cathode in weight.

4. The apparatus of claim 1, comprising:
the NCA material ranging between 30% to 50% of the composite cathode in weight and the NCM material ranging between 70% to 50% of the composite cathode in weight.

5. The apparatus of claim 1, comprising:
the composite cathode having a predefined content of nickel in the NCA material and the NCM material to attain a target specific capacity.

6. The apparatus of claim 1, comprising:
the composite cathode comprising a predefined ratio of the NCA material and the NCM material to attain a target thermal stability.

7. The apparatus of claim 1, comprising:
the composite cathode comprising a predefined ratio of the NCA material and the NCM material to attain a target retention capacity.

8. The apparatus of claim 1, comprising:
the composite cathode comprising a predefined ratio of the NCA material and the NCM material to attain a target energy density.

9. The apparatus of claim 1, comprising:
the composite cathode comprising a surface coated structure comprised of the NCA material and the NCM material.

10. The apparatus of claim 1, comprising:
the composite cathode comprising a spatial grading comprised of the NCA material and the NCM material.

11. The apparatus of claim 1, comprising:
the battery pack installed in the electric vehicle to power one or more components of the electric vehicle.

12. A method of providing battery cells to power electric vehicles, comprising:
disposing a battery pack in an electric vehicle to power the electric vehicle;
arranging a battery cell in the battery pack, the battery cell having a housing that defines a cavity within the housing of the battery cell;
arranging, within the cavity, an electrolyte having a first side and a second side to transfer lithium ions between the first side and the second side;
disposing, within the cavity, an anode disposed along the first side of the electrolyte, the anode electrically coupled with a negative terminal; and
disposing, within the cavity, a composite cathode along the second side of the electrolyte, the composite cathode electrically coupled with a positive terminal, the composite cathode comprising a lithium nickel cobalt aluminum oxide (NCA) material and a lithium nickel manganese cobalt oxide (NCM) material.

13. The method of claim 12, comprising:
disposing, within the cavity, the composite cathode comprising a blended mixture of the NCA material and the NCM material at a predetermined ratio to attain a target operating characteristic.

14. The method of claim 12, comprising:
setting the NCA material ranging between 75% to 85% of the composite cathode in weight and the NCM material ranging between 15% to 25% of the composite cathode in weight.

15. The method of claim 12, comprising:
setting the NCA material ranging between 30% to 50% of the composite cathode in weight and the NCM material ranging between 70% to 50% of the composite cathode in weight.

16. The method of claim 12, comprising:
installing the battery pack in the electric vehicle to power one or more components of the electric vehicle.

17. An electric vehicle, comprising:
one or more components;
a battery pack to power the one or more components; and
a battery cell arranged in the battery pack, the battery cell having a housing that defines a cavity within the housing of the battery cell, the battery cell having:
an electrolyte having a first side and a second side to transfer lithium ions between the first side and the second side, the electrolyte arranged within the cavity;
an anode disposed within the cavity along the first side of the electrolyte, the anode electrically coupled with a negative terminal; and
a composite cathode disposed within the cavity along the second side of the electrolyte, the composite cathode electrically coupled with a positive terminal, the composite cathode comprising a lithium nickel cobalt aluminum oxide (NCA) material and a lithium nickel manganese cobalt oxide (NCM) material.

18. The electric vehicle of claim 17, comprising:
the composite cathode comprising a blended mixture of the NCA material and the NCM material at a predetermined ratio to attain a target operating characteristic.

19. The electric vehicle of claim 17, comprising:
the NCA material ranging between 75% to 85% of the composite cathode in weight and the NCM material ranging between 15% to 25% of the composite cathode in weight.

20. The electric vehicle of claim 17, comprising:
the NCA material ranging between 30% to 50% of the composite cathode in weight and the NCM material ranging between 70% to 50% of the composite cathode in weight.
